(19) United States
(12) Patent Application Publication
(10) Pub. No.: US 2008/0005402 A1
(43) Pub. Date: Jan. 3, 2008

(54) Gals-based network-on-chip and data transfer method thereof

(75) Inventors: Dae-wook Kim, Seoul (KR); Man-ho Kim, Seoul (KR); Gerald E. Sobelman, Minneapolis, MN (US); Eui-seok Kim, Suwon-si (KR); Sang-woo Rhim, Seoul (KR); Beom-hak Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD.; REGENTS OF THE UNIVERSITY OF MINNESOTA

(21) Appl. No.: 11/410,117

(22) Filed: Apr. 25, 2006

(51) Int. Cl. G06F 5/00

(52) U.S. Cl. 710/52

(57) ABSTRACT

A GALS-based network-on-chip (NoC) includes a plurality of asynchronous first-in first-out (FIFO) input buffers connected to a plurality of IPs that asynchronously receive data; a plurality of asynchronous FIFO output buffers connected to the plurality of IPs asynchronously output data; and a router for forwarding data input to the plurality of asynchronous FIFO input buffers, to an asynchronous FIFO output buffer, among the plurality of asynchronous FIFO output buffers, which is connected to an IP to which the data is destined. Accordingly, the system-on-chip (SoC) adopting the GALS design scheme can transfer data via the NoC between the IPs which are in time zones having different clocks in the centralized switching system, thereby avoiding the need for a point-to-point system.

### BACKGROUND OF THE INVENTION

1. Field of the Invention

Apparatuses and methods consistent with the present invention relate to a network-on-chip (NoC) system based on globally asynchronous locally synchronous (GALS) technology and a data transfer method thereof.

2. Description of the Related Art

With the gradual convergence of computers, communications, broadcasts and the like, the need for existing application-specific integrated circuits (ASIC) and application-specific standard products (ASSP) are changing to a need for system-on-chip (SoC) systems. Additionally, the trend in information technology devices toward having a light and simple structure and intelligent function expedites the development of the SoC industry.

To reduce the time and effort required to design and inspect SoC, design approaches have been developed that drastically improve the SoC design productivity by introducing a design scheme that reuses intellectual property (IP) having verified function and performance.

FIGS. 1A through 1C depict conventional SoC design approaches using such IP.

As for the synchronous SoC design using a single global clock as shown in FIG. 1A, it requires addressing clock skew and jitter due to the speed-up of the clock, and the power consumption increases for the clock distribution. Furthermore, the SoC needs to be designed to take into account the delay time of the extended transmission line relative to the delay time of the element, and it is not easy to respond rapidly to market demands because of the increased design time resulting from the clock frequency difference between the IPs.

The globally asynchronous design as shown in FIG. 1B, does not utilize a global clock but performs the data transfer according to a handshake protocol irrelevant to the delay time. In this respect, the globally asynchronous design is presented as an alternative for overcoming the disadvantages of the synchronous SoC design which uses a single global clock. However, if the asynchronous circuit is enlarged, the design complexity increases and the testing becomes complicated. Also, asynchronous computer-aided design (CAD) tools are not enough to support the asynchronous design.

To overcome the above shortcomings, another alternative is to use a point-to-point globally asynchronous locally synchronous (GALS) design as shown in FIG. 1C. In the point-to-point GALS design, groups (hereafter, referred to as time zones) TZ1, TZ2, TZ3, and TZ4 include more than one IP which does not adapt the single global clock on the SoC but operates using independent clocks CLK1, CLK2, CLK3, and CLK4. The data transfer between the different time zones is conducted by wrappers 11 through 16 in conformity to the asynchronous handshake protocol.

However, the point-to-point GALS design exponentially increases the wiring complexity as the number of IPs operating at the independent clock increments, because one time zone should use the wrappers to interface with the other time zones in the point-to-point communication system.

Furthermore, the number of wrappers also exponentially increases to interface one time zone with the other time zones. Since the wrappers synchronize signals in the different time zones according to a pausible clocking scheme, the exponential increase of the wrappers may cause additional severe overhead to the SoC. A pausible clocking scheme is a scheme that avoids synchronization failure by adjusting the local clock. A synchronization failure at the module interface occurs when the arrival times of an external signal transition and a sampling edge of the clock are indistinguishable by the sampling latch at the module boundary. The synchronization failure is circumvented by pausing or stretching the local module clock when necessary.

### SUMMARY OF THE INVENTION

Apparatuses and methods consistent with the present invention address the above-mentioned and other problems and disadvantages occurring in the conventional arrangement, and an aspect of the present invention provides a network-on-chip (NoC) for reducing the wiring complexity by switching data in a centralized scheme, and alleviating the timing closure problem by transferring data to IPs through first-in first-out (FIFO) input and output buffers.

To achieve the above aspect of the present invention, a network-on-chip (NoC) for transferring data between a plurality of intellectual properties (IPs) which operates at independent clocks, includes a plurality of asynchronous first-in first-out (FIFO) input buffers connected to the plurality of IPs and asynchronously receiving data; a plurality of asynchronous FIFO output buffers connected to the plurality of IPs and asynchronously outputting data; and a router for forwarding data input to the plurality of asynchronous FIFO input buffers, to an asynchronous FIFO output buffer, among the plurality of asynchronous FIFO output buffers, which is connected to the IP to which the data is destined.

The asynchronous FIFO input buffer may receive the data according to the clock of the IP which inputs the data, and outputs the data to the router according to the clock of the NoC.

The asynchronous FIFO output buffer may receive the data from the router according to the clock of the NoC, and outputs the data according to the clock of the IP which receives the data.

A router configured for a network-on-chip (NoC) and transferring data between a plurality of intellectual properties (IPs) according to independent clocks, includes a plurality of asynchronous first-in first-out (FIFO) input buffers for asynchronously receiving data from an IP connected to the router or another router; a plurality of asynchronous FIFO output buffers for asynchronously outputting data to an IP connected to the router or another router; and a switch for forwarding data input to the plurality of asynchronous FIFO input buffers, to the plurality of asynchronous FIFO output buffers which is connected to an IP or another router to which the data is destined.

The switch may include a switch fabric for switching data input to the plurality of asynchronous FIFO input buffers and forwarding the switched data to an asynchronous FIFO output buffer which is connected to an IP or another router to which the data is destined; and an arbiter for arbitrating transfer of the data input to the plurality of asynchronous FIFO input buffers to the plurality of asynchronous FIFO output buffers via the switch fabric, whereby the arbitrating operates to avoid data transfer collisions.

The asynchronous FIFO input buffer may receive the data at a clock of an IP or another router which inputs the data.

The asynchronous FIFO output buffer may output the data at a clock of an IP or another router which receives the data.

A data transfer method of a network-on-chip (NoC) including more than one router which transfers data between a plurality of intellectual properties (IPs) operating at independent clocks, includes receiving data from an asynchronous FIFO input buffer which is connected to one of the plurality of IPs; routing the input data to a router which is connected to a destination IP to which the data is transferred; outputting and storing the data to an asynchronous FIFO output buffer which is connected to the destination IP; and outputting the data stored in the asynchronous FIFO output buffer, to the destination IP.

The receiving of the data from the asynchronous FIFO input buffer may be conducted at a clock of an IP which inputs the data.

The outputting of the data from the asynchronous FIFO output buffer to the destination IP may be conducted at a clock of the destination IP.

A system-on-chip (SoC) includes a plurality of intellectual properties (IPs) which operates according to independent clocks; and a network-on-chip (NoC). The NoC includes a plurality of asynchronous first-in first-out (FIFO) input buffers connected to the plurality of IPs and asynchronously receives data; a plurality of asynchronous FIFO output buffers connected to the plurality of IPs and asynchronously outputting data; and a router for forwarding data input to the plurality of asynchronous FIFO input buffers, to an asynchronous FIFO output buffer, among the plurality of asynchronous FIFO output buffers, which is connected to an IP to which the data is destined.

The asynchronous FIFO input buffer may receive the data at a clock of the IP which inputs the data.

The asynchronous FIFO output buffer may output the data at a clock of an IP which receives the data.

### BRIEF DESCRIPTION OF THE DRAWING FIGURES

These and/or other aspects and advantages of the invention will become apparent and more readily appreciated from the following description of non-limiting exemplary embodiments, taken in conjunction with the accompanying drawing figures of which:

FIGS. 1A through 1C are diagrams illustrating conventional system-on-chip (SoC) design approaches using IPs;

FIG. 2 is a conceptual diagram illustrating a network-on-chip (NoC)-based globally asynchronous locally synchronous (GALS) SoC according to an embodiment of the present invention;

FIG. 3 is a block diagram of a router in the NoC of FIG. 2;

FIG. 4 is a diagram illustrating the SoC including the NoC which has two routers according to an embodiment of the present invention;

FIG. 5 is a diagram depicting the SoC of FIG. 4, which is divided into time zones; and

FIG. 6 is a flowchart outlining a data transfer method of the NoC according to an embodiment of the present invention.

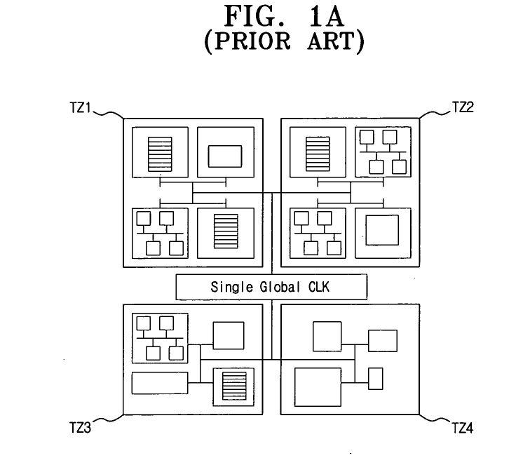

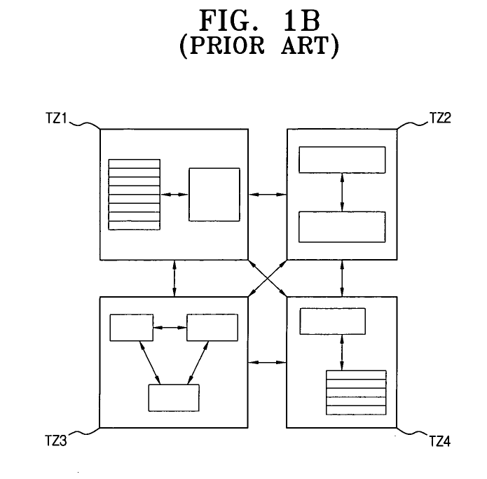

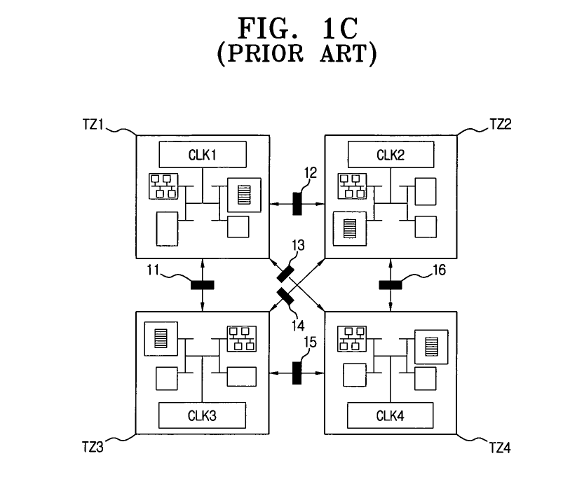

### DETAILED DESCRIPTION OF THE EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

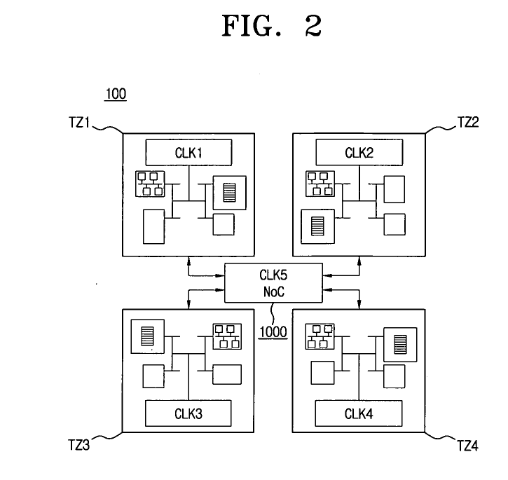

FIG. 2 is a conceptual diagram illustrating a network-on-chip (NoC)-based globally asynchronous locally synchronous (GALS) system-on-chip (SoC) according to an embodiment of the present invention.

Referring now to FIG. 2, in the NoC-based GALS SoC 100, a plurality of time zones TZ1, TZ2, TZ3, and TZ4 grouping intellectual properties (IPs) which operate at independent clocks CLK1, CLK2, CLK3, and CLK4, transfers data to and receives data from each other via the NoC 1000 that operates at a clock CLK5. As explained earlier, the time zone is a group including more than one IP that operates at the same clock.

According to an embodiment of the present invention, the IPs in the plurality of time zones TZ1, TZ2, TZ3, and TZ4 operate at the clock of the relevant time zones TZ1, TZ2, TZ3, and TZ4, and transfer data to a destination IP via the NoC 1000 without having to employ wrappers.

The NoC 1000 includes a plurality of routers (not shown in FIG. 2) that routes data so that the IPs can transfer data to other IPs in the SoC 100. Note that the plurality of routers can configure the NoC 1000 in other specific topologies depending on the system environment.

More particularly, the routers can exchange data with other routers or IPs via asynchronous first-in first-out (FIFO) buffers. The asynchronous FIFO buffers can receive and output data according to the two different clocks for receiving data and sending data. Thus, the asynchronous FIFO buffers, which are well-known devices in the related art, will not be explained in detail for simplicity.

With such a construction, there is no need to connect the time zones TZ1, TZ2, TZ3, and TZ4 operating at different clocks CLK1, CLK2, CLK3, and CLK4, directly to the other time zones in a point-to-point fashion for the exchange of data. Rather, all that is required are the connections to the NoC 1000. Therefore, the number of wrappers required for the data exchange between the time zones TZ1, TZ2, TZ3, and TZ4 can be reduced to the number of connections to the NoC 1000. Furthermore, in the case where routers that use asynchronous FIFO buffers are employed, wrappers are unnecessary.

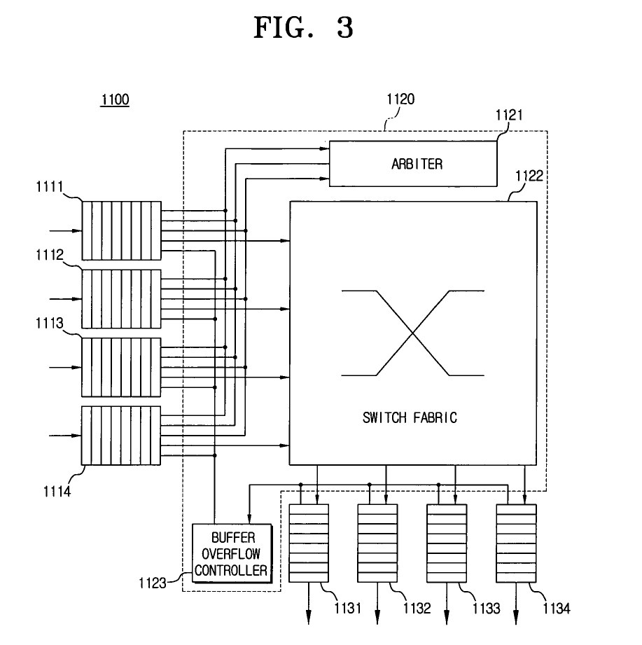

Hereafter, the routers are explained with reference to FIG. 3.

FIG. 3 is a block diagram of an exemplary router in the NoC 1000 of FIG. 2.

Referring to FIG. 3, the router 1100 includes a plurality of asynchronous FIFO input buffers 1111 through 1114, a switch 1120, and a plurality of asynchronous FIFO output buffers 1131 through 1134. The switch 1120 includes an arbiter 1121, a switch fabric 1122, and a buffer overflow controller 1123.

The asynchronous FIFO input buffers 1111 through 1114 receive data from an IP (not shown) connected to the router 1100 or another router (not shown), and output the data to the asynchronous FIFO output buffers 1131 through 1134 connected to an IP for which the data is destined or another router, via the switch fabric 1122 under the arbitration control of the arbiter 1121. The data input to the asynchronous FIFO input buffers 1111 through 1114 follows the clock of the IP or the other router transferring the data. The data output from the asynchronous FIFO input buffers 1111 through 1114 follows the clock of the router 1100.

The switch 1120 forwards the data input to the asynchronous FIFO input buffers 1111 through 1114, to the asynchronous FIFO output buffers 1131 through 1134 connected to an IP for which the data is destined or the other router.

Specifically, the arbiter 1121 controls the asynchronous FIFO input buffers 1111 through 1114 according to an arbitration scheme to forward the data to the asynchronous FIFO output buffers 1131 through 1134 via the switch fabric 1122 so that collisions do not occur.

The switch fabric 1122 switches the data stored in the asynchronous FIFO input buffers 1111 through 1114 and forwards the switched data to the asynchronous FIFO output buffers 1131 through 1134 that are connected to an IP or other router to which the data is destined.

The buffer overflow controller 1123 is responsible to control the asynchronous FIFO input buffers 1111 through 1114 so as not to receive further data when the asynchronous FIFO output buffers 1131 through 1134 are full of data.

The asynchronous FIFO output buffers 1131 through 1134 receive data from the asynchronous FIFO input buffers 1111 through 1114 and output the received data according to the clock of its connected IP or other connected router. Hence, the router 1100 enables the data exchange between IPs or routers that operate at different clocks.

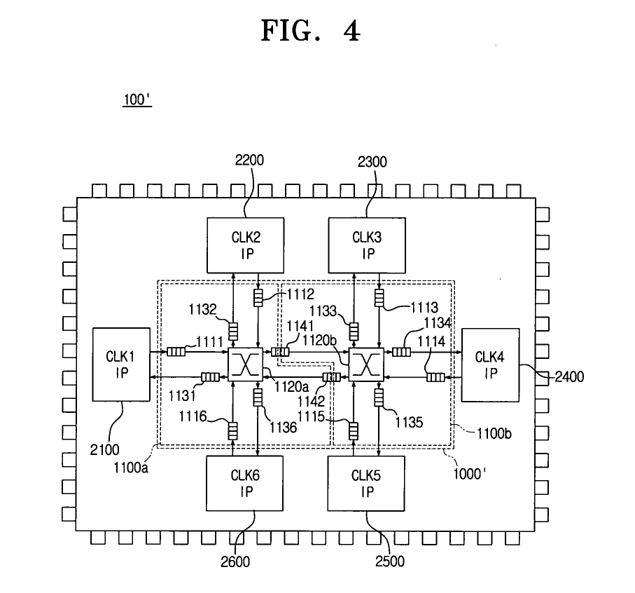

FIG. 4 is a diagram illustrating the SoC including the NoC which has two routers according to an embodiment of the present invention.

Referring to FIG. 4, the SoC 100′ includes a plurality of IPs 2100, 2200, 2300, 2400, 2500, and 2600 that operate at independent clocks CL1, CLK2, CLK3, CLK4, CLK5, and CLK6, and a NoC 1000′. The NoC 1000′ includes a first router 1100a and a second router 1100b. The first router 1100a includes a plurality of asynchronous FIFO input buffers 1111, 1112, 1116, and 1142, a plurality of asynchronous FIFO output buffers 1131, 1132, 1136, and 1141, and a first switch 1120a. The second router 1100b includes a plurality of asynchronous FIFO input buffers 1113, 1114, 1115, and 1141, a plurality of asynchronous FIFO output buffers 1133, 1134, 1135, and 1142, and a second switch 1120b.

The asynchronous FIFO buffers 1141 and 1142, which are equipped for the data exchange between the first router 1100a and the second router 1100b, are shared by the first and second routers 1100a and 1100b in the embodiment of the present invention shown in FIG. 4. It is to be understood that a separate asynchronous FIFO buffer can be provided to each of the first and second routers 1100a and 1100b for the data input and output to each other.

In more detail, the asynchronous FIFO input buffers 1111 through 1116 are connected to the IPs 2100 through 2600 operating at independent clocks, respectively, and receive and store data at the clocks CLK1 through CLK6 of the IPs 2100 through 2600.

The asynchronous FIFO input buffers 1111 through 1116 output the stored data to the first switch 1120a or the second switch 1120b at the clock of the NoC 1000′.

The asynchronous FIFO output buffers 1131 through 1136 are connected to the IPs 2100 through 2600 operating at independent clocks, respectively, and output the stored data at the clocks CLK1 through CLK6 of the IPs 2100 through 2600.

The asynchronous FIFO output buffers 1131 through 1136 receive data from the first switch 1120a or the second switch 1120b at the clock of the NoC 1000′.

If the first and second switches 1120a and 1120b are connected to a destination IP, they forward data which is input via the asynchronous FIFO input buffer to the asynchronous FIFO output buffer connected to the destination IP. By contrast, when the destination IP is connected to another switch, the first switch 1120a or the second switch 1120b forwards the data to an asynchronous FIFO output buffer connected to the other switch.

FIG. 4 shows that the NoC 1000′ includes the two routers 1100a and 1100b, however this is for ease in understanding the embodiment and is not a limitation of the NoC. It is to be appreciated that the number of routers and topology of the NoC 1000′ may vary depending on the number of time zones and the number of IPs in each time zone within the SoC.

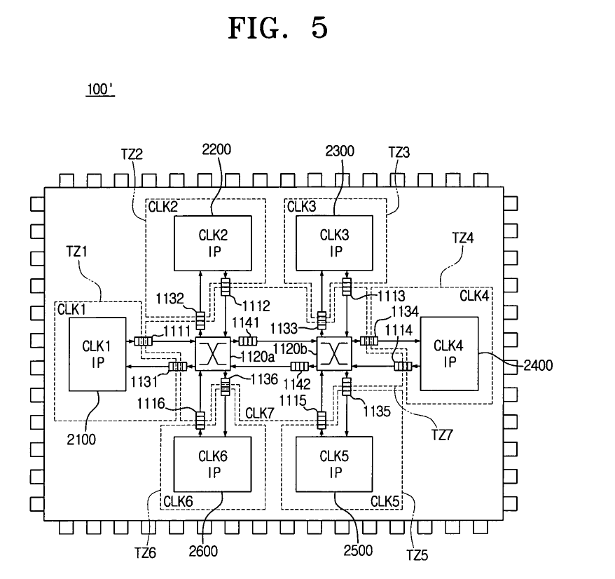

FIG. 5 is a diagram depicting the SoC of FIG. 4, which is divided into time zones.

Referring to FIG. 5, as can be seen, a plurality of IPs 2100, 2200, 2300, 2400, 2500, and 2600 operate at clocks CLK1, CLK2, CLK3, CLK4, CLK5, and CLK6 of the corresponding time zones TZ1, TZ2, TZ3, TZ4, TZ5, and TZ6.

The asynchronous FIFO input buffers 1111 through 1116 and the asynchronous FIFO output buffers 1131 through 1136, which are connected to the corresponding IPs 2100 through 2600, receive and output data from and to the IPs 2100 through 2600 at the clocks of the IPs 2100 through 2600. The first and second switches 1120a and 1120b, and the asynchronous FIFO buffers 1141 and 1142 of the NoC 1000′ operate at the clock CLK7 of the NoC 1000′.

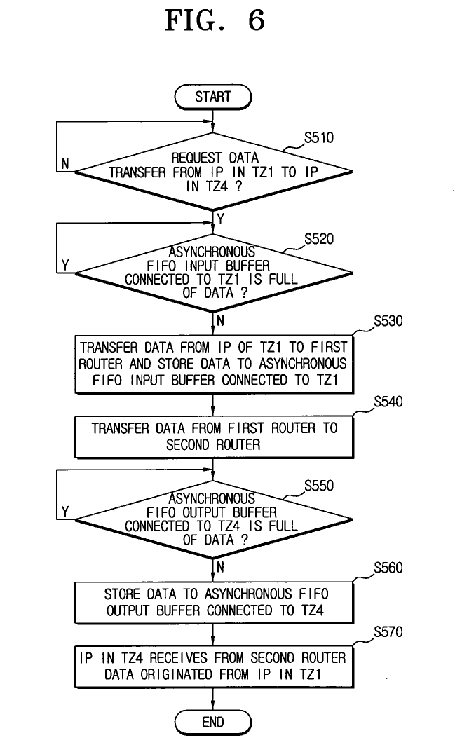

Hereafter, how the NoC 1000′ forwards data is described with reference to FIGS. 4 through 6. FIG. 6 is a flowchart outlining a data transfer method of the NoC according to an embodiment of the present invention.

For ease of understanding, an example is described in which data is transferred from IP 2100 of time zone TZ1 to IP 2400 of time zone TZ4.

Upon receiving a request from IP 2400 in the time zone TZ4 for a data transfer (S510), IP 2100 in time zone TZ1 checks whether asynchronous FIFO input buffer 1111 of the first router 1100a connected to time zone TZ1 is full of data (S520).

If the asynchronous FIFO input buffer 1111 is not full of data (S520-N), the IP 2100 transfers the data to the first router 1100a and the asynchronous FIFO input buffer 1111 stores the data (S530). The data input to the asynchronous FIFO input buffer 1111 is input at the clock CLK1 of the time zone TZ1 where the IP 2100 resides.

Next, the first router 1100a forwards the data to the second router 1100b which is connected to IP 2400 in time zone TZ4 (S540). In the embodiment of the present invention, the NoC 1000′ is configured with two routers and the data is transferred from the first router 1100a directly to the second router 1100b. Note that when the NoC 1000′ includes at least three routers, the data can be transferred along a route established between the first router 1100a and the second router 1100b.

The second router 1100b checks whether the asynchronous FIFO output buffer 1134 connected to the time zone TZ4 is full of data (S550). When the asynchronous FIFO output buffer 1134 is not full of data (S550-N), the second router 1100b causes the asynchronous FIFO output buffer 1134 to store the data (S560). The data input and output from operation S540 to operation S560 follows the clock CLK7 of the NoC 1000′.

The IP 2400 in the time zone TZ4 receives the data from the asynchronous FIFO output buffer 1134 at the clock CLK4 of the time zone TZ4 (S570). As a result, the IP 2100 of the time zone TZ1 and the IP 2400 of the time zone TZ4 transfer and receive data therebetween at the clock of their respective time zones without using wrappers.

As set forth above, the topology of the SoC can be simplified by the use of a NoC with a centralized switch system, and thus the wiring complexity can be reduced.

Furthermore, the NoC can facilitate the problem-solving of the timing closure by performing data input and output with the IP via the asynchronous FIFO buffer.

While the present invention has been particularly shown and described with reference to exemplary embodiments thereof, it will be understood by those skilled in the art that various changes in form and details may be made therein without departing from the spirit and scope of the invention as defined by the appended claims. The above-described embodiments should be considered in a descriptive sense only and are not for purposes of limitation. Therefore, the scope of the invention is defined not by the detailed description of the exemplary embodiments of the invention but by the appended claims, and all differences within the scope will be construed as being included within the scope of the present invention.

What is claimed is:

1. A network-on-chip (NoC) for transferring data between a plurality of intellectual properties (IPs) which operate according to independent clocks, comprising:
a plurality of input buffers connected to the plurality of IPs and configured to asynchronously receive data;
a plurality of output buffers connected to the plurality of IPs and configured to asynchronously output data; and
a router for forwarding data input to the plurality of input buffers, to an output buffer, among the plurality of output buffers, which is connected to an IP to which the data is destined.

2. The NoC of claim 1, wherein the plurality of asynchronous input buffers are first-in first-out (FIFO) input buffers and the plurality of output buffers are asynchronous FIFO output buffers.

3. The NoC of claim 2, wherein the asynchronous FIFO input buffer receives the data according to a clock of the IP which inputs the data, and outputs the data to the router according to a clock of the NoC.

4. The NoC of claim 2, wherein the asynchronous FIFO output buffer receives the data from the router according to the clock of the NoC, and outputs the data according to a clock of an IP which receives the data.

5. A first router configuring a network-on-chip (NoC) and transferring data between a plurality of intellectual properties (IPs) at independent clocks, comprising:
a plurality of input buffers configured to asynchronously receive data from an IP connected to one of the first router and a second router;
a plurality of output buffers configured to asynchronously output data to an IP connected to one of the first router, the second router and a third router; and
a switch configured to forward data input to at least one of the plurality of input buffers, to at least one of the plurality of output buffers which is connected to the IP or the router to which the data is destined.

6. The router of claim 5, wherein the plurality of asynchronous input buffers are first-in first-out (FIFO) input buffers and the plurality of output buffers are asynchronous FIFO output buffers.

7. The router of claim 6, wherein the switch comprises:
a switch fabric configured to switch data input to the plurality of asynchronous FIFO input buffers and forward the switched data to an asynchronous FIFO output buffer which is connected to the IP or the router to which the data is destined; and
an arbiter configured to arbitrate transfer of the data input to the plurality of asynchronous FIFO input buffers to the plurality of asynchronous FIFO output buffers via the switch fabric, whereby the arbitration avoids data collisions.

8. The router of claim 6, wherein the asynchronous FIFO input buffer receives the data according to a clock of the IP or router that inputs the data.

9. The router of claim 6, wherein the asynchronous FIFO output buffer outputs the data according to a clock of the IP or the router that receives the data.

10. A data transfer method of a network-on-chip (NoC) including more than one router which transfer data between a plurality of intellectual properties (IPs) operating at independent clocks, the method comprising:
receiving data from an input buffer which is connected to one of the plurality of IPs;
routing the input data to a router which is connected to a destination IP to which the data is transferred;
outputting and storing the data to an output buffer which is connected to the destination IP; and
outputting the data stored in the output buffer to the destination IP.

11. The method of claim 10, wherein the input buffer is an asynchronous first-in first-out (FIFO) input buffer and the output buffer is an asynchronous FIFO output buffer.

12. The data transfer method of claim 11, wherein the receiving of the data from the asynchronous FIFO input buffer is conducted at a clock of an IP which inputs the data.

13. The data transfer method of claim 11, wherein the outputting of the data from the asynchronous FIFO output buffer to the destination IP is conducted at a clock of the destination IP.

14. A system-on-chip (SoC) comprising:
a plurality of intellectual properties (IPs) which operate at independent clocks; and
a network-on-chip (NoC) which includes:
a plurality of asynchronous first-in first-out (FIFO) input buffers connected to the plurality of IPs and configured to asynchronously receive data;
a plurality of asynchronous FIFO output buffers connected to the plurality of IPs and configured to asynchronously output data; and
a router configured to forward data input to the plurality of asynchronous FIFO input buffers, to an asynchronous FIFO output buffer, among the plurality of asynchronous FIFO output buffers, which is connected to an IP to which the data is destined.

15. The SoC of claim 14, wherein the plurality of asynchronous input buffers are first-in first-out (FIFO) input buffers and the plurality of output buffers are asynchronous FIFO output buffers.

16. The SoC of claim 15, wherein the asynchronous FIFO input buffer is configured to receive the data according to a clock of the IP which inputs the data.

17. The SoC of claim 15, wherein the asynchronous FIFO output buffer outputs the data according to a clock of an IP which receives the data.
